(19) United States
(12) Patent Application Publication
(10) Pub. No.: US 2016/0279892 A1
(43) Pub. Date: Sep. 29, 2016

(54) Filter press for treating sludge and the corresponding method of pressing

(71) Applicant: TMCI PADOVAN S.P.A., Vittorio Veneto (IT)

(72) Inventor: Osman Erdal SAGMANLI, Istanbul (TR)

(21) Appl. No.: 15/031,761

(22) PCT Filed: Nov. 11, 2014
(86) PCT No.: PCT/IB2014/002405

§ 371 Date: Apr. 25, 2016

(30) Foreign Application Priority Data
Nov. 11, 2013 (IT) PN2013A000065

(51) Int. Cl. B30B 9/22; B01D 29/13; B01D 29/82; B30B 15/16

(52) U.S. Cl. CPC B30B 9/225; B30B 15/168; B01D 29/13; B01D 29/822

(57) ABSTRACT

A filter press, a pressing method and a pressing plant for treating sludge and separating a liquid fraction from a solid mass includes a filtration column having a loading/pressing module for the sludge, fixed and extending vertically, the loading/pressing module including a cylindrical outer shell, a perforated collector tube positioned inside the outer shell and disposed vertically, an impermeable membrane deformable under pressure and disposed between the outer shell and the perforated collector tube, and a pressing chamber defined by that surface of the membrane facing the perforated collector tube, wherein a filter is provided inside the pressing chamber about the outer wall of the collector tube, said the membrane is deformable by the inner wall of the outer shell towards the filter. and a shutter is provided in the bottom of the pressing chamber.

The present invention relates to a filter press for treating sludge of civil, industrial or foodstuff derivation, and a pressing method for separating the solid part from the liquid faction, and to achieve dehydration of the solid panel.

The filter press according to the present invention is particularly suitable for treating wine or must clarification bottoms, or the retained matter originating from a filtration plant, such substances being commonly known in oenology as “sludge”.

The process of pressing sludge of civil, industrial or foodstuff derivation aims at extracting the liquid fraction from the solid part, such as to obtain, as the pressing product, a solid dehydrated panel and a liquid part which may be reused after suitable filtration or other treatment. Filter presses are generally used to implement said separation and dehydration process.

In particular, in the oenological sector the term “sludge” generally defines the semi-solid product resulting from a grape filtration process, in the form of wine or must clarification sediments or bottoms, consisting of cells, in most cases yeasts, cream of tartar, pectin substances and those substances used as clarifiers (tannin, gelatin, bentonite, sal silica, PVPP, vegetable charcoal, albumin, etc.). This category also includes the retained matter originating from the filtration of must or wine in tangential filters. The sludge can also contain a certain quantity of residual liquid which can be used in lesser quality wine products.

In the oenological sector, filter presses are currently used comprising plate filters used to recover the liquid fraction, consisting of wine or must contained in pumpable sludge; these filters produce compact semi-solid panels, rich in tartaric substances and with a modest liquid content. The panels are then fed to specific alcohol and tartaric material industries to recover any residual liquid fraction and/or the substances contained in the panel.

This known type of filter press comprises a series of filter plates alternating with filter cloths which, by adhering one to another, form chambers in which the dehydrated sludge panel is formed. The sludge is pumped at high pressure into the filter, possibly using a filter aid, such as diatomaceous earth. The solid phase is retained in the interspaces between the plates and cloths while the liquid phase, of low suspended solids content, leaves from the filter press. The subsequent recovery of the solid phase is achieved by opening the filter press (manually or automatically) when the sludge has filled the interspaces or chambers.

A variant of the plate filter press is also available known as a membrane filter press in which, in the inner chamber of the plates, a membrane is interposed enabling the panel to be mechanically squeezed by inflating the membrane by subjecting it to compression.

EP 0714318 shows a membrane filter press formed substantially from a horizontally disposed cylinder comprising a perforated outer shell and an inner membrane deformable by pressure. After the product to be treated has been loaded into the membrane, a pressure is exerted which compresses the membrane and consequently the product contained in its interior; in this manner the liquid part of the product filters through the membrane to collect in the cylinder shell, from which it passes outwards through the perforations into a collection vessel, while the solid part remains in the membrane and is then discharged into a different collection vessel.

Although known filter presses provide sufficiently satisfactory results, they are not able to ensure that a solid panel is obtained which is dehydrated completely and homogeneously throughout its mass.

Such filter presses are also such that the machine is to a certain extent difficult to properly clean after the pressing process. In this respect, the peripheral drainage of the liquid fraction leaves on the outer shell a deposit of organic residues of the treated product which are particularly difficult to eliminate; with time, these residues ferment if not carefully removed, to contaminate the products obtained in the subsequent pressing cycles.

Another drawback encountered in known filter presses is their overall size in terms of the surface area occupied, because of the horizontal arrangement of the filtration column.

GB 1240465 describes a filter press in which the filtered liquid fraction is extracted from the top through a siphon tube, while to extract the dry solid mass the entire tubular body has to be extracted from the bottom axially. This involves a considerable constructional complexity, with slower and more laborious removal of both the liquid fraction and the solid mass.

FR 2166925 describes a filter press in which the pressure-deformable membrane pushes outwards against a perforated outer surface. Moreover, to implement pressing of the product, complex valve means are provided which create sequential wrinkling of the membrane.

EP 2106834 describes a filter press in which pressing is implemented by a deformable membrane, which urges the product to be pressed outwards against a perforated wall. The liquid fraction leaves the filtration column by falling into a conveyor which is open towards the outer environment.

EP 1338408 describes a horizontally extending press for agricultural products (grapes and fruit) which is able to rotate about its axis. Moreover, this press comprises several horizontally facing chambers in which the membrane compresses the product outwards against a perforated tube positioned about said membrane.

In particular, in FR 2166925, EP 2106834 and EP 1338408, the membrane is positioned at the centre of the column formed by the outer shell, with the filtration wall being interposed between said central membrane and said outer shell. Essentially, during pressing, the membrane deforms outwards and urges the product against the filtration wall, such that the liquid fraction enters the collection space defined between the filtration wall and the outer membrane. This solution causes product oxidation and also results in cleaning difficulty, with the risk of not guaranteeing a suitable level of hygiene.

GB 2158697 describes a machine for extracting juice (for example lemon juice) in which, in order to be able to load the material to be pressed, the upper cover has to be removed. In addition, the outer shell presents a curved shaped, difficult to achieve.

EP 585596 and EP 421503 describe presses for squeezing agricultural products to extract their juice, with the filtration columns rotating about a horizontal axis in both cases.

U.S. Pat. No. 3,624,729 describes a device for extracting juice from agricultural products, in which the filtration column extends horizontally and comprises a perforated conveying screw for advancing the pulp through the device.

The solutions of GB 2158697, EP 585596, EP 421503 and U.S. Pat. No. 3,624,729 are specifically intended for pressing agricultural products, and are not suitable for sludge.

An object of the invention is to propose a filter press for treating sludge and a pressing method, which are able to overcome the drawbacks of the known art.

Another object of the invention is to provide a filter press able to improve the final yield of dry substance by means of more effective and efficient extraction and separation of the liquid fraction.

Another object of the invention is to obtain a solid panel which is dehydrated completely and homogeneously throughout its entire mass.

Another object of the invention is to provide a filter press which enables the machine to be easily and properly cleaned in all its parts at the end of the working cycle.

Another object of the invention is to ensure a high degree of hygiene in the product treatment process, this being an essential characteristic for treating agro food products and their derivatives such as juices, wine and other products obtainable by squeezing fruit and the like.

Another object of the invention is to reduce the surface area occupied by the filter press.

Another object of the invention is to provide a filter press which achieves the aforestated task and objects at a competitive cost while using usual known machines, plants and equipment.

All these objects and others which will be apparent from the ensuing description are attained, according to the invention, by a filter press for sludge treatment as defined in claim 1, by a pressing method as defined in claim 20, and by a plant as defined in claim 25.

The present invention is further clarified by the description of two preferred embodiments thereof with reference to the accompanying drawings, in which:

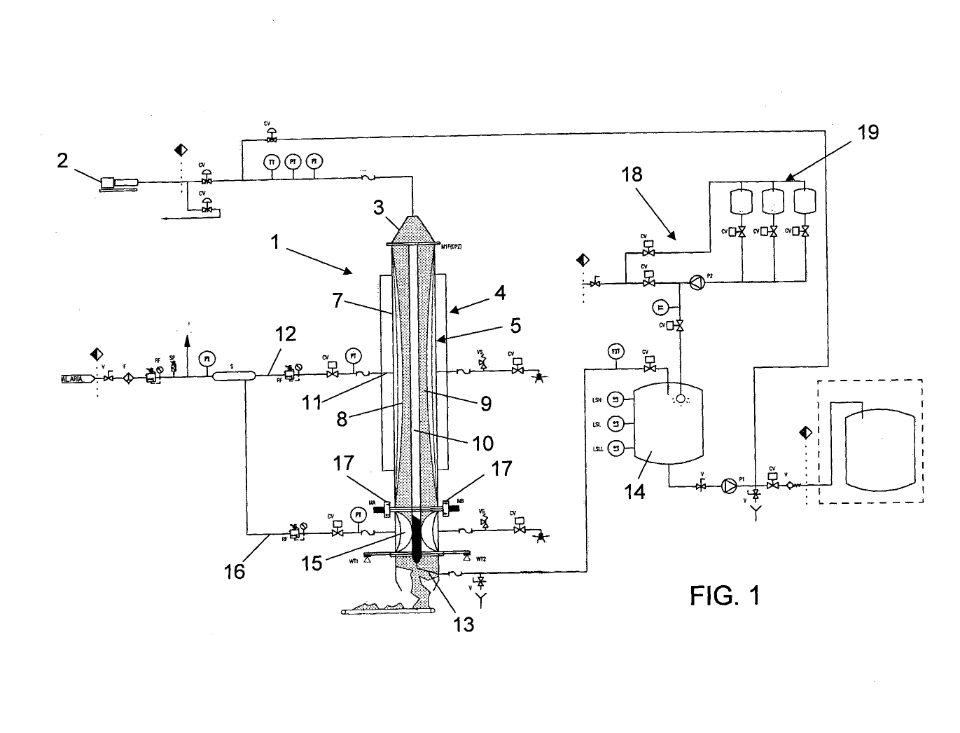

FIG. 1 shows a scheme of a pressing plant comprising a filter press according to the present invention;

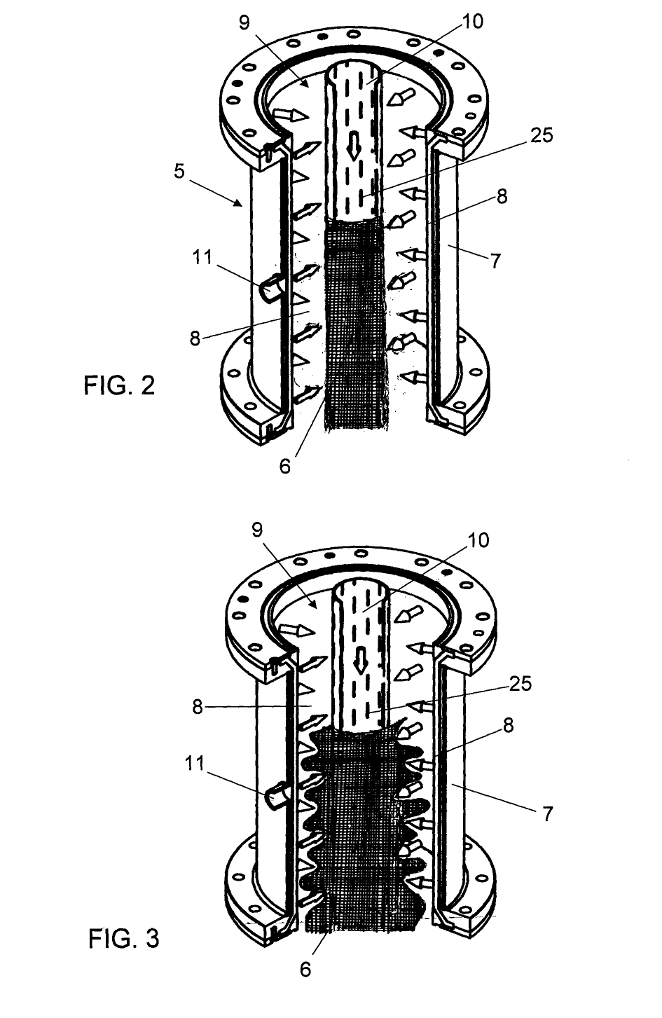

FIG. 2 is a cut-away view of a detail of a first embodiment of the filter press, and

FIG. 3 shows, in the same view as FIG. 2, a detail of a different embodiment of the filter press.

With reference to said figures, FIG. 1 shows a scheme of a pressing plant comprising at least one filter press 1 according to the present invention for treating sludge of civil, industrial or foodstuff derivation.

In the ensuing description, the term “sludge” defines a substance comprising a solid mass inside which a liquid fraction is contained. In the oenological sector the term “sludge” generally defines the semi-solid substances resulting from a grape filtration process, in the form of sediments or wine or must clarification bottoms, or the retained matter originating from wine or must filtration, as already described in the introduction to the present description.

The mass of sludge to be treated, originating from a tank, is fed by pumping means 2 to the entry mouth 3 of the filter press 1, which comprises at least one filtration column 4 which extends vertically with respect to the ground or to a reference plane parallel to the ground and comprises at least one loading/pressing module 5. In addition, the filtration column 4 is fixed in its vertical position, i.e. it cannot rotate about its axis.

During the loading stage the column 4 is filled with the sludge mass to be treated, until a predetermined pressure value is reached, measured by a suitable pressure probe positioned at the inlet to the column 4.

From the entry mouth 3 the sludge mass is transferred to the loading/pressing module 5, which comprises an essentially cylindrical outer shell 7, with the interior of which at least one pressure-deformable impermeable membrane 8 is associated which defines in its interior a pressing chamber 9. With reference to FIGS. 2 and 3, showing by way of example a cut-away view of the loading/pressing module 5, at least one perforated collector tube 10, provided with through holes 25, is disposed inside the pressing chamber 9. Both the outer shell 7 and the perforated collector tube 10 are disposed vertically with respect to the ground or to a reference plane parallel to the ground. Preferably, a single perforated collector tube 10 is provided, coaxial to the outer shell 7.

Between the outer shell 7 and the membrane 8 connected to the outer shell 7 at its upper and lower edges, an interspace is provided to enable passage for a pressurized fluid, preferably air, through an aperture 11 connectable to a first pneumatic circuit 12. The pressurized fluid introduced into the interspace of the shell 7 through the aperture 11 is able to deform the impermeable membrane 8 such as to withdraw it from the inner walls of the shell 7 and compress it radially towards the centre of the pressing chamber 9 where the perforated collector tube 10 is located. In this manner, the impermeable membrane 8 exerts a radial compression on the sludge contained in the pressing chamber 9 such as to separate the liquid fraction from the solid mass.

The collector tube 10 is covered, or wrapped about its outer wall, with filtration means 6 comprising, for example, one or more filter cloths (or meshes) externally surrounding the collector tube 10. The filtration (i.e. the separation of the liquid fraction from the solid mass of sludge) is implemented by the filtration means 6, while the main function of the perforated collector tube 10 is to support and sustain the said filtration means. In particular, the filtration means 6 have a porosity of the order of microns while the holes 25 of the perforated collector tube 10 have dimensions of the order of millimetres.

The filtration means 6 are formed separately from the perforated collector tube 10. In particular, the filtration means 6 can be in strict contact with the collector tube 10, i.e. substantially adhering thereto (see FIG. 2), Alternatively, the filtration means 6 can be loose (non-adhering) on the collector tube 10 (see FIG. 3); in this case, the fact that the filtration means 6 consist of a non-taut cloth, and the effect of the interspace present between this and the collector tube 10, enable the thrust caused by the membrane 8 to corrugate and wring said filter cloth 6.

The filtration means 6 are preferably made of plastic material (for example polypropylene, or polyamide, cotton, acrylic, PVC or polyester fibre), however they can also be made of sintered porous steel; in this latter case, the collector tube 10 wrapped by the filtration means 6 can advantageously be made of a metal (for example steel) suitable for structurally stiffening the porous filtration means.

The fact that the filter press 1 is intended to treat sludge, means that the filtration means 6 must, as stated, have a porosity of the order of microns, preferably substantially between 1 and 150 microns (μm); this distinguishes them from the filtration means provided in presses intended for treating fruit or other agricultural products, which instead have a porosity of the order of millimetres.

When the column 4 has been loaded with the sludge to be treated, the pressing or dehydration cycle begins, involving an alternating series of compressions and decompressions of the impermeable membrane 8 which determines progressive pressing of the sludge contained in the pressing chamber 9 such as to separate the residual liquid part contained therein; by effect of the radial compression exerted by the membrane 8 against filtration means 6, this liquid fraction is separated from the solid mass and is extracted radially towards the centre of the pressing chamber 9, where it is collected by the perforated collector tube 10 disposed at the centre of the chamber 9.

In particular, the liquid part previously filtered by passage through the filtration means 6 flows into the collector tube 10 through the holes 25 provided in the tube 10 itself, and is conveyed towards the bottom of the filtration column 4 where the volume of the possibly filtered liquid fraction is suitably measured by suitable measuring instruments.

The liquid fraction then leaves to the outside of the filtration column 4 through its base. In particular, an outlet conduit 13, which is inserted into the base of the column 4 and is directly connected to the lower end of the collector tube 10 transfers the volume of liquid to a collection tank 14, advantageously provided with an electrically-operated level indicator and an electrically driven pump which automatically provide for its evacuation. The direct connection between the lower end of the collector tube 10 and the outlet conduit 13 is necessary to prevent that the filtered liquid fraction comes into contact with the air of the external environment; this prevents the filtered liquid fraction from being able to be contaminated by impurities or other damaging micro-organisms present in the air of the external environment. In particular, in applications in the oenological sector, the liquid fraction obtained by filtering the sludge consists substantially of wine, hence the absence of contact with the air of the external environment is necessary to prevent oxidation of the filtered wine. Furthermore, the fact that a direct connection exists between the lower end of the collector tube 10 and the outlet conduit 13 means that a closed system is defined, isolated from the outer environment, which can be advantageously made inert by feeding suitable inert gases (for example argon or nitrogen).

On the base of the pressing chamber 9, shutter means are provided, movable between a closed position, in which they lowerly close the pressing chamber 9 in order to retain the sludge to be filtered within the chamber itself during the pressing stage, and an open position in which, during the discharge stage, define at least one passage to enable the solid mass of sludge to leave by gravity to the outside of the chamber.

In particular, the shutter means provided at the bottom of said pressing chamber 9 can be defined by suitably controlled movable vanes or, preferably, by valving means 15. In greater detail, these valving means 15 are positioned at the bottom of the filtration column 4 upstream of the outlet conduit 13, and comprise for example a sleeve valve controlled by a second pneumatic circuit 16 for a pressurized fluid. During the loading and pressing stage the valving means 15 are maintained in the closed position by the effect of the pressurized fluid fed into the valve body to retain the sludge mass in the interior of the pressing chamber 9 until the end of the cycle, to extract the greatest amount of liquid possible; during the discharge stage the valving means 15 are instead opened, by pressure release, to enable discharge of the now substantially completely dehydrated residual solid mass remaining at the end of the pressing cycle.

The discharge stage, involving passage of the shutter means provided in the bottom of the pressing chamber 9 from the closed position to the open position, is started automatically when suitable load cells no longer sense a substantial fall in the weight of the solid mass (i.e. when the measured weight reaches a value which remains substantially constant). To facilitate separation of the dehydrated solid panel, and hence emptying of the pressing chamber 9, suitable vibrating means 17 can be advantageously provided at the base of the filtration column 4.

The pressure for deforming the membrane 8 and the valve 15 is provided by one or more pneumatic compressors connected to the first pneumatic circuit 12 and to the second pneumatic circuit 16 and advantageously controlled by control means such as a PLC.

In particular, in contrast to the pressing cycle for fruit or agricultural products, in which the membrane is deformed once only, particularly quickly in incremental manner, in the sludge pressing cycle according to the present invention, the deformation of the membrane 8 is repeated several times, constantly and alternatingly. In this manner, each deformation of the membrane 8 deforms the sludge mass present in the pressing chamber 9 such as to create within the mass itself new channels for passage of the liquid fraction, enabling a better and more complete sludge filtration to be achieved.

The column 4 can be suitably washed at the end of the pressing cycle, for example to remove the organic residues left by the treated product, in order to prevent their fermentation which could cause contamination of the subsequent products to be treated. For this purpose a suitable wash circuit is provided, indicated overall by the reference numeral 18, communicating with the filtration column 4 inlet circuit via the collection tank 14. The wash circuit 18 can also comprise dispenser means for the wash detergents.

In particular, after emptying the collection tank 14 of the filtered liquid fraction, the wash liquid (for example, water with possible detergents) is fed to the interior of the tank, and from there through the wash circuit 18 to reach the inlet to the filtration column 4. This is then washed by free fall along the entire column 4, with optimal results and without the need to feed pressurized water into the column.

According to the invention, a pressing plant can also be provided comprising a plurality of filter presses 2, as heretofore described, disposed in such a manner as to operate in series and/or in parallel.

From the aforegoing it is hence apparent that the present invention achieves the initially stated objects and advantages; in this respect a filter press for treating sludge of civil, industrial or foodstuff derivation, and a relative pressing method have been provided able to overcome the drawbacks of the known art.

In particular, from the aforegoing it is apparent that the filter press according to the invention is much more advantageous than traditional filter presses in that:
it enables the sludge to be filtered particularly quickly and completely, hence ensuring a treatment which is both efficient and effective,
it does not require any filtration aid, which would otherwise have to be disposed of with further additional costs,
it is easy to clean and ensures a high degree of hygiene,
it is completely automatic, and in particular does not require any manual intervention, nor any manning by operators,
it is modular, in that each filtration column is independent of the others; this enables the filter press to be suitably dimensioned, and to also adapt it later on the basis of specific production requirements of each user.

In greater detail, the sludge pressing and the separation of the liquid fraction by the filtration means 6, and the fact that this fraction is then collected and conveyed along the central collector tube 10, in fact enables these operations to be made more effective, so improving the final yield of dry substance, consisting of the solid panel which is dehydrated substantially in a complete and homogeneous manner throughout its mass.

The improved final yield also provides further advantages in economic terms, both in transport costs and in the disposal of a mass no longer containing substantially any liquid part in its interior, hence resulting in a lesser weight and a greater ease of disposal.

The vertical arrangement of the column 4 also enables the surface area occupied by the press to be considerably reduced, in contrast to similar known generally horizontally disposed plants, in addition to enabling the wash to be implemented by free fall with optimal and more efficient results, enabling a high degree of hygiene to be achieved, particularly required in treating agro food products.

A preferred embodiment of the present invention has been illustrated, however it is susceptible to numerous applications, modifications or variants, without however leaving the scope of protection of the present industrial invention patent.

In this respect, a press according to the present invention, in addition to its use in the agro food or oenological sector as aforedescribed, can also be used in the chemical industry, the pharmaceutical industry, in water treatment, and in all those sectors in which a solid part has to be separated from a liquid part and dehydrated.

The materials and equipment used for implementing the present invention, and the forms and dimensions of the individual components can be the most suitable in accordance with specific requirements.

The invention claimed is:

1. A filter press for treating sludge for separating a liquid fraction from a solid mass, comprising at least one filtration column (4) which includes at least one loading/pressing module (5) for said sludge, said filtration column (4) being fixed and extending vertically with respect to a reference plane parallel to a ground, said loading/pressing module (5) comprising:
a cylindrical outer shell (7) disposed vertically to said reference plane parallel to the ground,
at least one perforated collector tube (10) positioned inside said outer shell (7) and disposed vertically with respect to said reference plane parallel to the ground,
at least one impermeable membrane (8) deformable under pressure and disposed between said outer shell (7) and said perforated collector tube (10),
for said sludge, a pressing chamber (9) defined by that surface of said membrane (8) facing said at least one perforated collector tube (10),
wherein:
a filter (6) is provided inside said pressing chamber about an outer wall of said at least one collector tube (10) to separate the liquid fraction of said sludge from the solid mass of said sludge, said filter (6) being loosely disposed about the outer wall of said collector tube (10),
said membrane (8) is deformable by an inner wall of said outer shell (7) towards said filter (6) such to compress said sludge, contained in said pressing chamber (9), against said filter (6) and hence to separate, by way of said filter (6), the liquid fraction of said sludge and cause the liquid fraction to enter inside said perforated collector tube (10), while the solid mass of said sludge remains in said pressing chamber (9) but outside of said filter (6) provided about the perforated collector tube (10),
the liquid fraction which enters inside said collector tube (10), descends through said tube to then emerges a the bottom of the filtration column (4), and
a shutter (15) are provided in a bottom of the pressing chamber (9), movable between a closed position, in which the shutter lowerly closes said pressing chamber (9) such to retain inside the pressing chamber said sludge to be filtered, and an open position in which the shutter defines at least one passage to enable the solid mass of said filtered sludge to escape from the pressing chamber (9), essentially by gravity.

2. The filter press as claimed in claim 1, wherein said liquid fraction, after passing through said filter (6), is immediately collected in said perforated collector tube (10) positioned at a centre of said pressing chamber (9).

3. The filter press as claimed in claim 1, wherein a deformation of said impermeable membrane (8) is achieved by connecting said outer shell (7) to a first pneumatic circuit (12) for a pressurized fluid.

4. The filter press as claimed in claim 1, wherein a single collector tube (10) is provided coaxial with said outer shell (7).

5. The filter press as claimed in claim 1, further comprising an outlet conduit (13) provided at the bottom of said filtration column (4) and connected directly to a lower end of said collector tube (10) such as to define a closed system isolated from an outer environment.

6. (canceled)

7. The filter press as claimed in claim 1, wherein said membrane (8) is connected to the outer shell (7) along an upper edge and a lower edge thereof.

8. The filter press as claimed in claim 1, wherein said filter (6) comprises at least one filter cloth which externally wraps the collector tube (10).

9.-11. (canceled)

12. The filter press as claimed in claim 1, wherein said filter (6) is of sintered porous steel stiffened internally by said collector tube (10).

13. The filter press as claimed in claim 1, wherein the shutter provided on the bottom of said pressing chamber (9) comprises movable vanes, and/or a valve (15) controlled by a second pneumatic circuit (16) for a pressurized fluid.

14.-15. (canceled)

16. The filter press as claimed in claim 1, wherein passage of the shutter provided at the bottom of the pressing chamber (9), from a closed position to an open position, is started automatically based on measurements by load cells arranged to measure a weight of the solid mass present within the pressing chamber (9).

17. The filter press as claimed in claim 1, wherein said filtration column (4) is configured to vibrate, such to facilitate exit of the filtered solid mass from the pressing chamber (9).

18. The filter press as claimed in claim 1, further comprising a wash circuit for feeding a wash liquid to an inlet of the filtration column (4), a washing of said filtration column (4) taking place essentially by free fall of the wash liquid through the filtration column.

19. The filter press as claimed in claim 18, wherein said wash liquid, before being fed to the inlet of the filtration column (4), passes through and cleans a collection tank (14), once the collection tank has been emptied of said filtered liquid fraction.

20. A sludge pressing method for separating a liquid fraction from a solid mass in a filter press in accordance with claim 1, comprising:
loading sludge to be pressed into a filtration column (4) comprising at least one pressing chamber (9),
pressing said sludge by an alternating repeated compression oriented from a periphery towards a centre of said at least one pressing chamber (9), such to separate the liquid fraction from the solid mass through a filter (6); the liquid fraction being conveyed towards an outlet conduit (13) by at least one perforated collector tube (10) disposed inside said pressing chamber (9); and
discharging the solid mass of said filtered sludge outside of said pressing chamber (9), essentially by gravity.

21. The sludge pressing method as claimed in claim 20, wherein performance of some or all of the steps of the method is completely automated.

22. The sludge pressing method as claimed in claim 20, further comprising, after the step of discharging, a step of washing said filtration column (4) by free fall of a wash liquid through the filtration column.

23. The sludge pressing method as claimed in claim 20,
wherein, during the step of pressing said sludge, compressions are repeated until a weight of said solid mass contained in said pressing chamber (9) reaches a value which remains substantially constant, and
wherein the step of discharging the solid mass from said pressing chamber (9) begins once it has been found, during the step of pressing, that a weight of said solid mass contained in said pressing chamber (9) has settled to a substantially constant value.

24. (canceled)

25. A pressing plant comprising:
at least two filter presses in accordance with claim 1, operating in series and/or parallel.
